(19) United States
(12) Patent Application Publication
(10) Pub. No.: US 2005/0273533 A1
(43) Pub. Date: Dec. 8, 2005

(54) Computer system, and device, in particular computer mouse or mobile telephone for use with the computer system

(75) Inventor: Peter Hughes, Bristol (GB)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation, Irvine, CA (US)

(21) Appl. No.: 11/146,188

(22) Filed: Jun. 7, 2005

Related U.S. Application Data
(60) Provisional application No. 60/577,215, filed on Jun. 7, 2004.

(51) Int. Cl. G06F 13/38; G06F 13/12; G06F 3/00

(52) U.S. Cl. 710/62

(57) ABSTRACT

The invention refers to a computer system, comprising: a computer, and a peripheral device, wherein the computer comprises one or more receivers for receiving signals sent from the peripheral device, and a peripheral device movement detector for detecting a movement of the peripheral device from the signals received from the peripheral device. Further, the invention referes to a mobile telephone, comprising a device movement tracking member, e.g., a rollerball. In addition, the invention refers to a computer system, comprising: a mobile telephone comprising a device movement tracking member, and a computer connectable to the mobile telephone, e.g. via a wireless RF connection.

### CROSS-REFERENCE TO RELATED APPLICATIONS

This application claims benefit to U.S. Provisional Application No. 60/577,215 filed on Jun. 7, 2004, entitled “Computer System, and Device, In Particular Computer Mouse or Mobile Telephone for Use with the Computer System” which is incorporated by reference herein in its entirety.

### BACKGROUND OF THE INVENTION

The invention generally relates to computer systems, and, more particularely, to a computer, and a device, in particular a peripheral device, e.g. a computer mouse, or a mobile telephone, etc., for use with the computer.

In the state of the art, mobile, wireless telephones are well known, and generally include an elongated body having a gripping portion so as to be hand-held, a speaker portion which is held near the user's ear, and a microphone portion that is positioned near the user's mouth when in use.

Mobile, wireless telephones generally communicate with so-called base stations of wireless telephone service suppliers, e.g. making use of the GSM-, or the UMTS-standard.

Further, so-called computer mice are well known in the art. A computer mouse might comprise input members such as click members or buttons, and a mouse movement tracking member such as a rolling ball.

The mouse might be connected via a respective wire to a computer, and might be used to control the computer, e.g., by making use of a cursor controlled by a movement of the mouse, and shown on a respective screen of the computer.

### SUMMARY OF THE INVENTION

The invention is aimed at making available a novel device, in particular, computer peripheral device, e.g. a novel computer mouse, and/or a novel mobile telephone for use with a computer, and a novel computer, and a novel computer system.

According to an aspect of the invention, a computer system comprises: a computer, and a peripheral device, wherein the computer comprises one or more receivers for receiving signals sent from the peripheral device, and a peripheral device movement detector for detecting a movement of the peripheral device from the signals received from the peripheral device.

According to a further aspect of the invention, a computer is provided, comprising one or more receivers for receiving signals sent from a peripheral device, and a peripheral device movement detector for detecting a movement of the peripheral device from the signals received from the peripheral device.

According to an additional aspect of the invention, a peripheral device is provided, comprising a reflector adapted to reflect signals sent from a computer, for a movement detector comprised by said computer to detect a movement of the peripheral device from the reflected signals.

The peripheral device might e.g. be a mobile phone.

According to a further aspect of the invention, a mobile telephone comprises a telephone movement tracking member.

Advantageously, the telephone movement tracking member comprises a rollerball.

According to another aspect of the invention, a computer system comprises: a mobile telephone comprising a telephone movement tracking member, and a computer connectable to the mobile telephone, e.g. via a wireless RF connection.

### BRIEF DESCRIPTION OF THE DRAWINGS

The above and other features, aspects and advantages of the present invention will be more fully understood when considered with respect to the following detailed description, appended claims and accompanying drawings, wherein:

FIG. 1 is diagrammatic view illustrating an embodiment of a computer system;

FIG. 2 is a perspective view illustrating an embodiment of a computer system;

FIG. 3 is a perspective view illustrating an embodiment of a mobile phone, additionally working as a mouse, which might be used in the computer system, viewed from above;

FIG. 4 is a perspective view illustrating an embodiment of a mobile phone, additionally working as a mouse, which might be used in the computer system, viewed from below;

FIG. 5 is a perspective view illustrating an alternative embodiment of a computer system; and

FIG. 6 is a perspective view illustrating a further alternative embodiment of a computer system.

### DETAILED DESCRIPTION

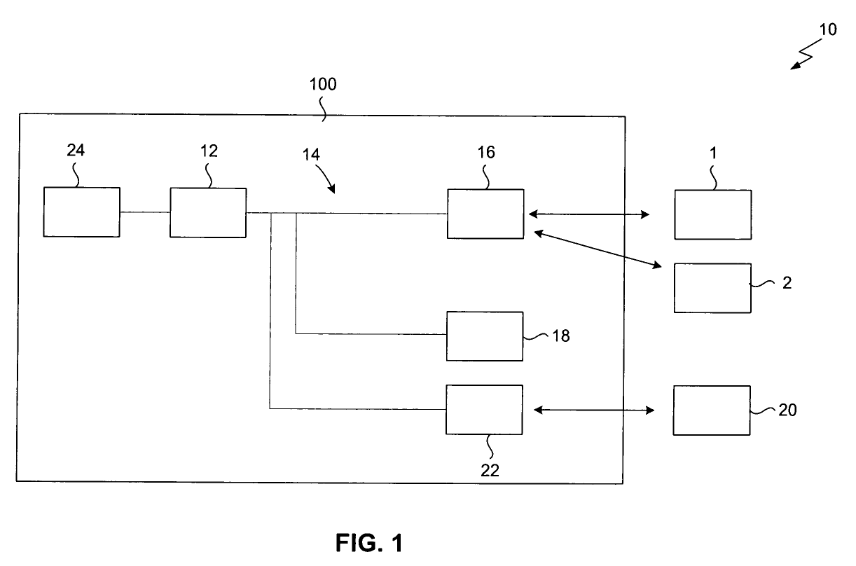

In an embodiment as shown in FIG. 1, a computer system 10 comprises a computer 100, e.g., a PC (Personal Computer), or a laptop computer.

The computer 100 includes a microprocessor 12, which is connected to a bus system 14. The bus system 14 serves as a connection between microprocessor 12 and other components of the computer 100. An input system 16 comprising and/or interacting with one or several (internal or peripheral) input devices 1, 2 is coupled to the microprocessor 12 to provide input to the microprocessor 12. Examples of input devices 1, 2 include keyboards, touchscreens, and pointing devices such as mouses, trackballs and trackpads, as well as the—special—computer peripheral device 1 as described in further detail below.

Programs and data are stored on a mass storage device 18, which is coupled to the microprocessor 12. Mass storage devices include such devices as hard disks, optical disks, magneto-optical drives, floppy drives and the like. The Computer 100 further includes a display 20, which is coupled to the microprocessor 12 by a video controller 22. A system memory 24 is coupled to microprocessor 12 to provide the microprocessor 12 with fast storage to facilitate execution of computer programs by the microprocessor 12. It should be understood that other busses and intermediate circuits can be deployed between the components described above, and the microprocessor 12 to facilitate interconnection between the components and the microprocessor 12.

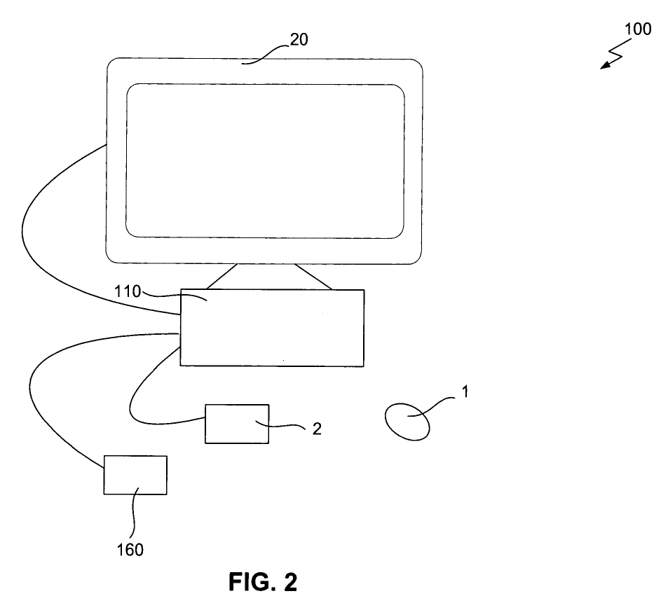

FIG. 2 illustrates a perspective view of the computer system 10, and the computer 100 shown in FIG. 1 (here: a PC (Personal Computer)), providing an environment within which the present embodiments can operate.

The PC 100 comprises a main chassis 110 containing e.g. the bus system 14, the input system 16, the mass storage device 18, the system memory 24, etc.

Coupled through individual connectors on the main chassis 110 are the above display 20, a keyboard 2, which constitute—together with the above computer peripheral device 1, which will be described in further detail below—respective external data input and output devices.

A printer 160 is also shown coupled to a parallel port on a rear surface of the main chassis 110. The parallel port allows the PC 100 to send character or graphical data to the printer 160 for printing thereby. The peripheral devices 1, 2, 20, 160 allow the PC 100 to interact with a user.

The above peripheral device 1—in a first embodiment—might be a mobile, wireless telephone, e.g. a GSM-, or UMTS-telephone, similar to conventional mobile telephones, but being adapted such as to additionally fulfill the function of a conventional computer mouse.

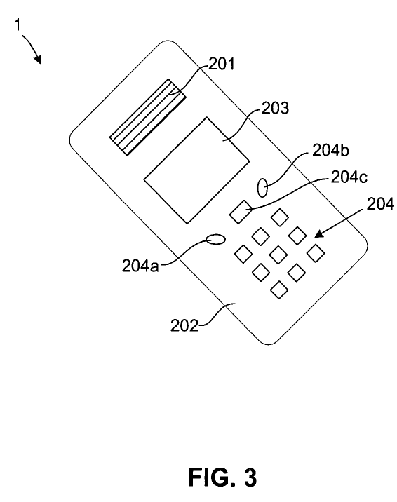

For instance—just as ordinary mobile phones, and as is shown in FIG. 3—the peripheral device 1 might comprise an elongated body 202 having a gripping portion so as to be hand-held, a speaker portion 201 which is held near the user's ear, and a microphone portion that is positioned near the user's mouth when in use, a display 203, and several keyes 204, which might correspond to the keys of an ordinary mobile phone, and which are used to control the mobile phone functions of the peripheral device 1.

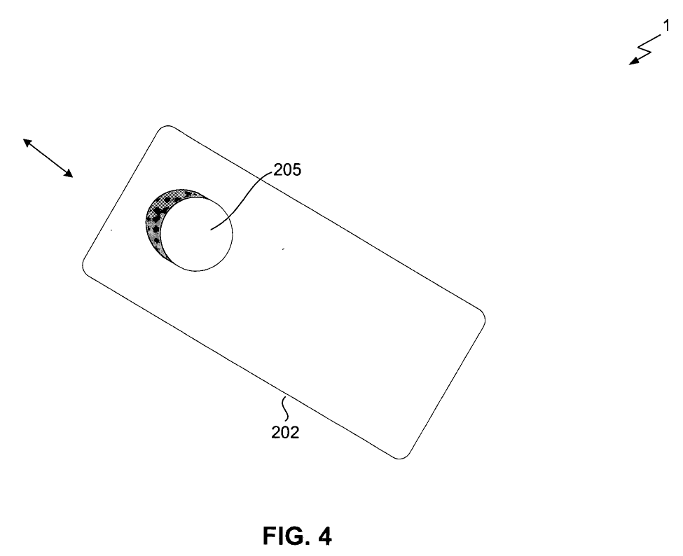

Other than ordinary mobile phones,—just as ordinary computer mice, and as is shown in FIG. 4—the peripheral device 1 additionally includes a device movement tracking member, here: a rollerball 205.

After starting a special program stored on a memory of the peripheral device 1, a first key 204a, and a second key 204b of the above keyes 204 (and, e.g. one or several further keys 204b)—usually used to control the mobile phone functions of the peripheral device 1—might be used as input members working correspondingly as input members known from ordinary computer mice.

For instance, the first key 204a might then be used as a first computer mouce click member, the second key 204b as a second computer mouce click member (and a third key 204c as a third computer mouce click member, etc.).

The peripheral device 1 might than—just as an ordinary mouse—be used to control the computer 100, e.g., by making use of a cursor controlled by the movement of the peripheral device 1 with respect to e.g. a mousepad, or any other kind of surface, and shown on the display 20 of the computer 100.

The data input at the respective keyes 204a, 204b, and the data derived from tracking the movement of the peripheral device 1, e.g. by the device movement tracking member, here: the rollerball 205, might be sent to the computer 100, e.g. the above computer input system 16 e.g. correspondingly to what is known for ordinary mice, e.g., via a respective wire connected between the peripheral device 1, and the computer 100, or—advantageously—wireless, e.g., by use of an ordinary wireless connection usually employed to connect an ordinary mouse to a computer, e.g., a wireless connection based on infrared light.

Alternatively, the wireless connection might also be a RF (radio frequency) connection, e.g. similar to wireless connections employed by ordinary mobile phones (e.g., similar to a GSM-, or UMTS-connection), or any other kind of RF-connection (e.g., a W-LAN connection), and/or, might be a wireless connection e.g. making use of an antenna provided at the peripheral device 1 (not shown), and also used for the transmittal/receipt of data when the peripheral device 1 is used as mobile phone.

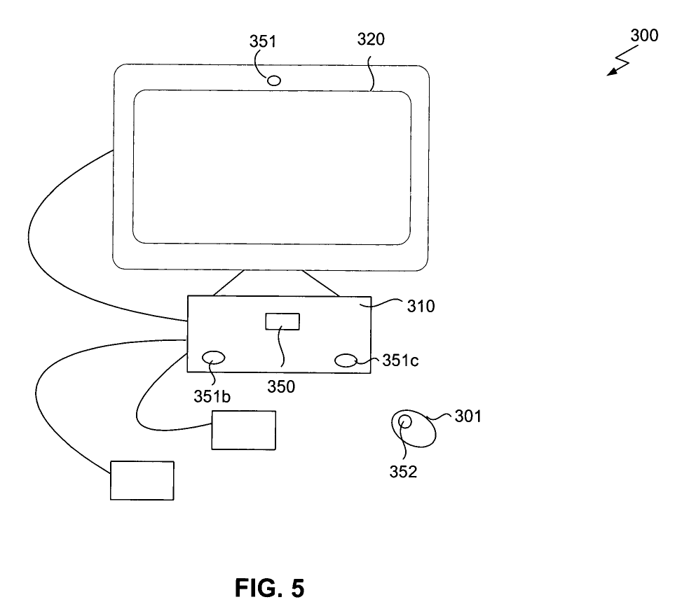

In the alternative embodiment shown in FIG. 5, a peripheral device 301 might be built similar to the peripheral device 1 described above, but might not comprise an “active” device movement tracking member such as a rollerball (and—alternatively—might even not be supplied with the above mobile phone capability).

Instead, the position and/or movement of the peripheral device 301 is tracked by a position/movement tracking system comprised by the computer 300, e.g. comprising an RF signal generator 350, in particular, an RF pulse signal generator, and several (e.g. three) triangulated relative phase detectors 351a, 351b, 351c.

A first detector 351a might be located at the display 320 of the computer 300, and the second and third detector 351b, 351c—spaced apart from another—at the front of the chassis 310 of the computer 300.

Further, the peripheral device 301 might be equipped with an RF signal reflector 352, e.g., a piece of metal.

The RF signals, in particular, RF pulse signals sent out by the RF signal generator 350 are reflected by the RF signal reflector 352, and thus sent back towards the direction of the first, second and third phase detectors 351a, 351b, 351c.

From respective phase differences between the signals received by the first, second and third phase detectors 351a, 351b, 351c, in particular, from respective differences in the arrival times of respective, corresponding signal pulses or edges thereof at the first, second and third phase detectors 351a, 351b, 351c, the position and/or movement of the peripheral device 301 might be detected (e.g., by use of the above processor 12, and a respective software program loaded on the storage device 18, e.g. similar to a position and/or movement detection program as applied in conventional radar systems).

The position and/or movement data (as e.g. calculated by the processor 12)—just as the movement data provided by ordinary movement tracking members of ordinary mice—might be used to control the computer 300, e.g., by making use of a cursor controlled by the detected position and/or movement of the peripheral device 301 with respect to the computer 300, in particular, the above phase detectors 351a, 351b, 351c.

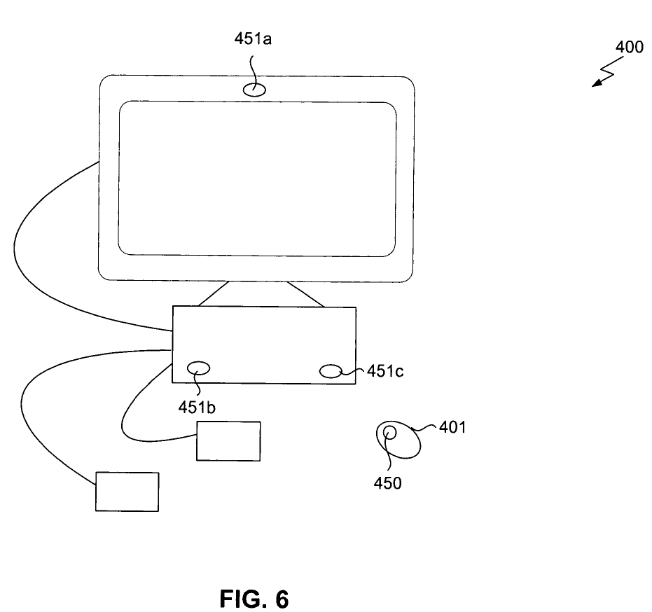

As is shown in FIG. 6, in an alternative embodiment, an RF signal generator 450 corresponding to the RF signal generator 350 shown in FIG. 5 might be provided at the peripheral device 401, instead of at the computer 400.

In this case, the the peripheral device 401 needs not to be equipped with a RF signal reflector.

The RF signal generator 450—corresponding to the RF signal generator 350—might send out a low-power RF pulse signal every few milliseconds.

Again, from respective phase differences between the signals received by first, second and third phase detectors 451a, 451b, 451c which correspond to the phase detectors 351a, 351b, 351c shown in FIG. 5, the position and/or movement of the peripheral device 401 might be detected.

The position and/or movement data—just as the movement data provided by ordinary movement tracking members of ordinary mice—might be used to control the computer 400, e.g., by making use of a cursor controlled by the detected position and/or movement of the peripheral device 401 with respect to the computer 400, in particular, the above phase detectors 451a, 451b, 451c.

While certain examplary embodiments have been described in detail and shown in the accompanying drawings, it is to be understood that such embodiments are merely illustrative of and not restrictive on the broad invention. It will thus be recognized that various modifications may be made to the illustrated and other embodiments of the invention, without departing from the scope and spirit of the invention as defined by the appended claims.

1. A computer system, comprising:
a computer, and a peripheral device, wherein the computer comprises one or more receivers for receiving signals sent from the peripheral device, and a peripheral device movement detector for detecting a movement of the peripheral device from the signals received from the peripheral device.

2. The computer system of claim 1, wherein the computer comprises at least two receivers.

3. The computer system of claim 2, wherein the peripheral device movement detector comprises a phase difference detector for detecting a phase difference between the signals received from the peripheral device at said at least two receivers.

4. The computer system of claim 2, wherein the computer comprises a sender adapted to sending out signals, and the peripheral device comprises a reflector adapted to reflecting the signals towards said at least two receivers.

5. The computer system of claim 1, wherein the peripheral device comprises a sender.

6. The computer system of claim 2, wherein the computer comprises at least three receivers.

7. The computer system of claim 6, wherein the receivers are located in a triangular position.

8. A computer, comprising one or more receivers for receiving signals sent from a peripheral device, and a peripheral device movement detector for detecting a movement of the peripheral device from the signals received from the peripheral device.

9. The computer of claim 7, comprising at least two receivers.

10. The computer of claim 9, wherein the peripheral device movement detector comprises a phase difference detector for detecting a phase difference between the signals received from the peripheral device at said at least two receivers.

11. The computer of claim 9, comprising a sender adapted to sending out signals reflected by the peripheral device towards said at least two receivers.

12. The computer of claim 9, comprising at least three receivers.

13. The computer of claim 12, wherein the receivers are located in a triangular position.

14. A peripheral device, comprising a reflector adapted to reflect signals sent from a computer, for a movement detector comprised by said computer to detect a movement of the peripheral device from the reflected signals.

15. The peripheral device of claim 14, wherein the peripheral device is a mobile phone.

16. A peripheral device, comprising a sender adapted to send signals to a computer, for a movement detector comprised by said computer to detect a movement of the peripheral device from the sent signals.

17. Mobile telephone, comprising a telephone movement tracking member.

18. The mobile telephone of claim 17, wherein the telephone movement tracking member comprises a rollerball.

19. A computer system, comprising:
the mobile telephone of claim 17, and a computer connectable to the mobile telephone.

20. The computer system of claim 19, wherein the mobile telephone is connectable to the computer via a wireless connection.

21. The computer system of claim 20, wherein the wireless connection is a RF connection.
